(19) United States
(12) Patent Application Publication
(10) Pub. No.: US 2022/0357179 A1
(43) Pub. Date: Nov. 10, 2022

(54) METHOD AND APPARATUS FOR CONSTRUCTING NAVIATION ELEMENT IN MAP

(71) Applicant: Shanghai SenseTime Lingang Intelligent Technology Co., Ltd., Shanghai (CN)

(72) Inventors: Wenqiang LI, Shanghai (CN); Yuqian LIU, Shanghai (CN)

(21) Appl. No.: 17/870,293

(22) Filed: Jul. 21, 2022

Related U.S. Application Data
(63) Continuation of application No. PCT/CN2021/098685, filed on Jun. 7, 2021.

(30) Foreign Application Priority Data
Mar. 31, 2021 (CN) 202110351703.9

(51) Int. Cl. G01C 21/00; G01C 21/32

(52) U.S. Cl. CPC G01C 21/3819; G01C 21/3881; G01C 21/3867; G01C 21/32

(57) ABSTRACT

The disclosure provides a method and apparatus for constructing a navigation element in a map, a computer device and a readable storage medium. Various kinds of road information are recognized through semantic map data, roads are divided through lane lines, and road elements are added to the divided road blocks according to location information of the road elements so as to obtain a navigation map.

### CROSS-REFERENCE TO RELATED APPLICATIONS

This application is a continuation of International Application No. PCT/CN2021/098685, filed on Jun. 7, 2021, which claims priority to Chinese Patent Application No. 202110351703.9, filed to the China National Intellectual Property Administration on Mar. 31, 2021 and entitled “Method and Apparatus for Constructing Navigation Element in Map”. The contents of International Application No. PCT/CN2021/098685 and Chinese Patent Application No. 202110351703.9 are hereby incorporated by reference in their entireties.

### BACKGROUND

With the development and progress of science and technologies, automobiles have gradually entered more and more families, and have brought great convenience for trips of users. With the development of automobile technologies, automatic driving has gained more and more attention due to advantages such as that drivers can be released, some traffic accidents caused by driver's errors can be avoided, drunk driving, malicious driving and other behaviors can be reduced, and the safety of road traffic can be effectively improved.

Automatic driving allows vehicles to automatically perform perceiving, planning and decision-making without manual intervention. Herein, perceiving, planning and decision-making are based on an electronic map. The electronic map not only needs to provide semantic elements of roads, such as boundary lines, lane lines, traffic lights, etc., but also needs to provide navigation elements to provide lane information and connection relationships among the semantic elements.

### SUMMARY

The disclosure relates to the technical field of computers, and more particularly, to a method and apparatus for constructing a navigation element in a map, a computer device and a readable storage medium.

According to a first aspect, the embodiments of the disclosure provide a method for constructing a navigation element in a map, which may include: recognizing, according to semantic map data of a target area, road element information in the target area and at least two road boundary lines and a plurality of lane lines in the road element information; determining at least one road in the target area and at least one lane line located in each of the at least one road based on the at least two road boundary lines and the plurality of lane lines that are recognized; dividing each of the at least one road into a plurality of consecutively arranged road blocks based on the at least one lane line in the road; and adding each road element to a corresponding road block according to location information of the road element in the road element information to obtain a navigation map for road navigation.

According to a second aspect, the embodiments of the disclosure further provide an apparatus for constructing a navigation element in a map, which may include an element recognition module, a lane determination module, a lane division module, and an element adding module.

The element recognition module is configured to recognize, according to semantic map data of a target area, road element information in the target area and at least two road boundary lines and multiple lane lines in the road element information. The lane determination module is configured to determine at least one road in the target area and at least one lane line located in each of the at least one road based on the at least two road boundary lines and the multiple lane lines that are recognized. The lane division module is configured to divide each of the at least one road into multiple consecutively arranged road blocks based on the at least one lane line in the road. The element adding module is configured to add each road element to a corresponding road block according to location information of the road element in the road element information to obtain a navigation map for road navigation.

According to a third aspect, the embodiments of the disclosure provide a computer device, including a processor, a memory and a bus. The memory stores machine-readable instructions executable by the processor. When the computer device runs, the processor and the memory are communicated through the bus. When executed by the processor, the machine-readable instructions execute a method for constructing a navigation element in a map, the method including: recognizing, according to semantic map data of a target area, road element information in the target area and at least two road boundary lines and a plurality of lane lines in the road element information; determining at least one road in the target area and at least one lane line located in each of the at least one road based on the at least two road boundary lines and the plurality of lane lines that are recognized; dividing each of the at least one road into a plurality of consecutively arranged road blocks based on the at least one lane line in the road; and adding each road element to a corresponding road block according to location information of the road element in the road element information to obtain a navigation map for road navigation.

According to a fourth aspect, the embodiments of the disclosure provide a non-transitory computer-readable storage medium having stored thereon a computer program that, when run by a processor, causes the processor to execute for constructing a navigation element in a map, the method including: recognizing, according to semantic map data of a target area, road element information in the target area and at least two road boundary lines and a plurality of lane lines in the road element information; determining at least one road in the target area and at least one lane line located in each of the at least one road based on the at least two road boundary lines and the plurality of lane lines that are recognized; dividing each of the at least one road into a plurality of consecutively arranged road blocks based on the at least one lane line in the road; and adding each road element to a corresponding road block according to location information of the road element in the road element information to obtain a navigation map for road navigation.

According to a fifth aspect, the embodiments of the disclosure further provide a computer program product, including a computer readable code, or a nonvolatile computer readable storage medium carrying the computer readable code, wherein the computer readable code, when runs in a processor of an electronic device, causes the processor of the electronic device to execute the operations of the above-mentioned method for constructing a navigation element in a map.

In order to make the above-mentioned purposes, features and advantages of the disclosure more obvious and easy to understand, detailed descriptions of preferred embodiments are made below with reference to the accompanying drawings.

### BRIEF DESCRIPTION OF THE DRAWINGS

In order to more clearly explain the technical solutions of the embodiments of the disclosure, the drawings needed in the embodiments will be briefly introduced below. The drawings herein are incorporated into and constitute a part of the specification, which illustrate embodiments in accordance with the disclosure and together with the specification serve to explain the technical solutions of the disclosure. It is to be understood that the following drawings only illustrate some embodiments of the disclosure, and therefore should not be regarded as limitations to the scope. For those of ordinary skill in the art, other related drawings may also be obtained in accordance with these drawings without creative efforts.

FIG. 1 illustrates a flowchart of a method for constructing a navigation element in a map according to embodiments of the disclosure.

FIG. 2 illustrates a flowchart of another method for constructing a navigation element in a map according to embodiments of the disclosure.

FIG. 3 illustrates a schematic diagram of an intersection according to embodiments of the disclosure.

FIG. 4 illustrates a schematic diagram of calculation of steering information according to embodiments of the disclosure.

FIG. 5 illustrates a schematic diagram of division of road blocks according to embodiments of the disclosure.

FIG. 6 illustrates a schematic diagram I of an apparatus for constructing a navigation element in a map according to embodiments of the disclosure.

FIG. 7 illustrates a schematic diagram II of an apparatus for constructing a navigation element in a map according to embodiments of the disclosure.

FIG. 8 illustrates a schematic diagram of a computer device according to embodiments of the disclosure.

### DETAILED DESCRIPTION

In order to make the purposes, technical solutions and advantages of the embodiments of the disclosure clearer, the technical solutions in the embodiments of the disclosure will be clearly and completely described below in combination with the drawings in the embodiments of the disclosure, and it is apparent that the described embodiments are only a part rather all of embodiments of the disclosure. Components of the embodiments of the disclosure generally described and illustrated here in the drawings may be arranged and designed in various different configurations. Therefore, the following detailed descriptions of the embodiments of the disclosure provided in the drawings are not intended to limit the scope of the claimed disclosure, but only represent selected embodiments of the disclosure. All other embodiments obtained by those skilled in the art based on the embodiments of the disclosure without creative efforts shall fall within the protection scope of the disclosure.

It is found through studies that planning and decision-making of vehicle driving in automatic driving is based on an electronic map. The electronic map not only needs to provide semantic elements of roads, such as boundary lines, lane lines, traffic lights, etc., but also needs to provide navigation elements to provide lane information and connection relationships among the semantic elements. However, the main way of generating navigation elements is to perform manual marking through a marking tool, which is not only high in manual marking cost, but also time-consuming, labor-consuming, inefficient and error-prone.

Based on the studies above, the disclosure provides a method for constructing a navigation element in a map. Various kinds of road information are recognized through semantic map data, roads are divided through lane lines, and road elements are added to the divided road blocks according to location information of the road elements so as to obtain a navigation map, thereby achieving completely automatic construction of the elements. An error rate of road element marking can be reduced, and a large amount of marking time and labor costs are saved. Both time and labor are saved, and a high accuracy is achieved.

The defects of the above solutions are all the results obtained by inventors through practice and careful research. Therefore, the discovery process of the above problems and the solutions to the above problems proposed in the disclosure below both should be the inventors' contributions to the disclosure in the process of the disclosure.

It is to be noted that similar numbers and letters indicate similar items in the following drawings, so once a certain item is defined in one drawing, no further definitions and explanations are required for same in the subsequent drawings.

In order to facilitate the understanding of the embodiment, firstly, a detailed introduction is made to a method for constructing a navigation element in a map disclosed in the embodiments of the disclosure. An executive subject of the method for constructing a navigation element in a map provided in the embodiments of the disclosure is generally a computer device with certain computing capabilities. The computer device includes, for example, a terminal device or a server or other processing devices. The terminal device may be User Equipment (UE), a mobile device, a user terminal, a terminal, a cellular phone, a cordless phone, a Personal Digital Assistant (PDA), a handheld device, a computing device, a vehicle-mounted device, a wearable device, etc. In some possible implementations, the method for constructing a navigation element in a map may be implemented in a manner that a processor calls computer-readable instructions stored in a memory.

Descriptions are made below to the method for constructing a navigation element in a map provided in the embodiments of the disclosure by taking the executive subject as a terminal device as an example.

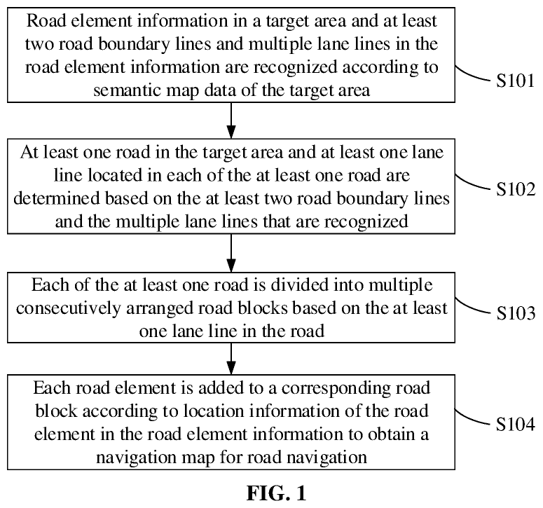

Referring to FIG. 1, FIG. 1 illustrates a flowchart of a method for constructing a navigation element in a map according to embodiments of the disclosure. As illustrated in FIG. 1, the method includes the following operations.

At S101, road element information in a target area and at least two road boundary lines and multiple lane lines in the road element information are recognized according to semantic map data of the target area.

In this operation, a semantic map to be converted into a navigation map may be acquired, and road element information in the target area and at least two road boundary lines and multiple lane lines in the road element information may be obtained by recognizing the semantic map data.

The road element information may include road elements contained in the target area, location information of the road elements, etc.

Herein, the road elements, for example, may include one or more of the following: a stop line which may be constituted by a column of points, the order of the points following the travel direction of a road; zebra stripes, which are mostly rectangles composed of four points; road marks, such as various arrows on the road surface, which may be made up of multiple boundary points, are unlimited in number, and may be used to indicate steering attributes of the road; traffic lights which may be formed with four boundary points in a map, including a turning attribute and an orientation, etc.

Herein, the road boundary line refers to a boundary line of a road. The at least two road boundary lines may refer to at least two boundary lines belonging to various roads in the target area.

In addition, a lane line and a road boundary line are two kinds of road elements, respectively. That is, the road element information includes lane lines and road boundary lines, and may further include attribute information, location information, etc. about the lane lines and the road boundary lines. A road boundary line may be constituted by a column of points, and the order of the points follows the travel direction of the road. A lane line is constituted by a column of points, and the order of the points follows the travel direction of the road. The lane line may have an attribute indicating a dotted line or a solid line, a color attribute, etc.

At S102, at least one road in the target area and at least one lane line located in each of the at least one road are determined based on the at least two road boundary lines and the multiple lane lines that are recognized.

In this operation, after the at least two road boundary lines and the multiple lane lines are obtained, at least one road in the target area may be determined by information of each road boundary line, for example, by matching locations of the road boundary lines, and at least one lane line in each road may be determined by the relationship between information such as the locations of the lane lines and factors such as the locations of the roads.

At S103, each of the at least one road is divided into multiple consecutively arranged road blocks based on the at least one lane line in the road.

In this operation, each road may be divided by lane lines in the road so that the road is divided into multiple consecutively arranged road blocks.

Herein, the road may be divided according to the direction of the road, that is, the direction in which a vehicle travels in the road.

Thus, the size of a road unit requiring road element matching can be reduced. The road unit is refined so as to improve the matching degree and accuracy of the road element to the road.

At S104, each road element is added to a corresponding road block according to location information of the road element in the road element information to obtain a navigation map for road navigation.

In this operation, after multiple road blocks are obtained by division, road elements may be added to corresponding road blocks through matching of location information so as to obtain a navigation map.

According to the method for constructing a navigation element in a map provided in the embodiment of the disclosure, various kinds of road information are recognized through semantic map data, roads are divided through lane lines, and road elements are added to the divided road blocks according to location information of the road elements so as to obtain a navigation map, thereby achieving completely automatic construction of the elements. An error rate of road element marking can be reduced, and a large amount of marking time and labor costs are saved. Both time and labor are saved, and a high accuracy is achieved.

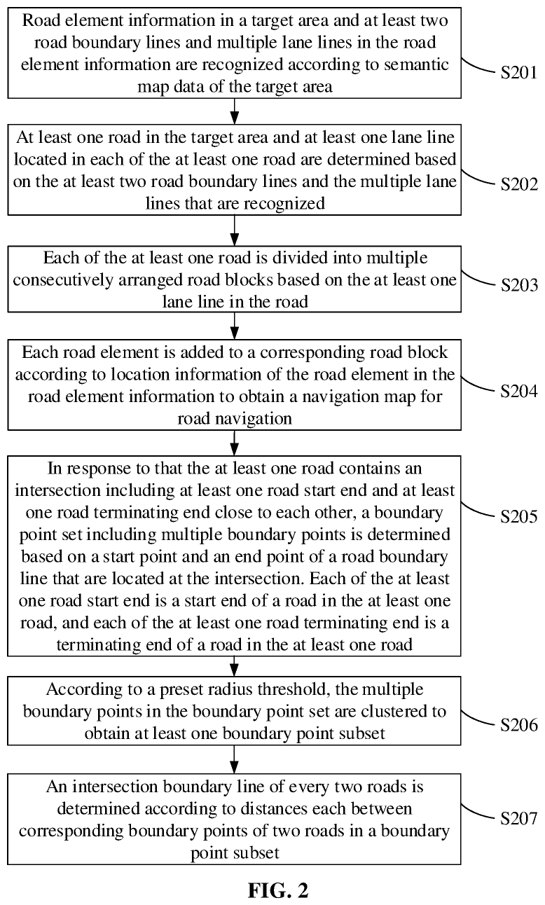

Referring to FIG. 2, FIG. 2 illustrates a flowchart of another method for constructing a navigation element in a map according to embodiments of the disclosure. As illustrated in FIG. 2, the method includes the following operations.

At S201, road element information in a target area and at least two road boundary lines and multiple lane lines in the road element information are recognized according to semantic map data of the target area.

At S202, at least one road in the target area and at least one lane line located in each of the at least one road are determined based on the at least two road boundary lines and the multiple lane lines that are recognized.

At S203, each of the at least one road is divided into multiple consecutively arranged road blocks based on the at least one lane line in the road.

At S204, each road element is added to a corresponding road block according to location information of the road element in the road element information to obtain a navigation map for road navigation.

Herein, the description of operations S201 to S204 may refer to the description of operations S101 to S104, and the same technical effect can be achieved and the same technical problem can be solved, which will not be repeated here.

At S205, in response to that the at least one road contains an intersection including at least one road start end and at least one road terminating end close to each other, a boundary point set including multiple boundary points is determined based on a start point and an end point of a road boundary line that are located at the intersection. Each of the at least one road start end is a start end of a road in the at least one road, and each of the at least one road terminating end is a terminating end of a road in the at least one road.

In this operation, after at least one road is recognized, the at least one road may be detected to recognize whether there is an intersection in the at least one road. If yes, start points or end points of road boundary lines located in the intersection may be unified into the same boundary point set by means of clustering, etc., so as to obtain a boundary point set including multiple boundary points for unified processing.

Herein, the start point or the end point of each road boundary line may be used as a boundary point of a corresponding road. A boundary point set may include a start point and an end point that belong to different road boundary lines, but the start point and the end point of the same road boundary line are not included in the same boundary point set.

Herein, the road start end is the start end of any one of the at least one road. The terminating end of the road is the terminating end of any one of the at least one road. Moreover, the road start end and the road terminating end may belong to the same road or may belong to two different roads respectively. The at least one road start end and at least one road terminating end close to each other may refer to that a distance between a road start end and a road terminating end, a distance between a road terminating end and another road terminating end, and a distance between a road start end and a road start end are less than a certain distance threshold. For example, in practical applications, a corresponding distance threshold may be set by comprehensively considering factors such as the width of a road and the range of an intersection.

At S206, according to a preset radius threshold, the multiple boundary points in the boundary point set are clustered to obtain at least one boundary point subset.

In this operation, in order to process each intersection, the boundary point set may be clustered according to a preset radius threshold so as to obtain a corresponding boundary point subset of each intersection.

At S207, an intersection boundary line of every two roads is determined according to distances each between corresponding boundary points of two roads in a boundary point subset.

In this operation, after the boundary point subset including the boundary points is obtained, the intersection boundary line of every two roads may be constructed through the distances each between the corresponding boundary points of two roads.

Specifically, for each boundary point subset, a closest road may be determined for each road according to locations of all boundary points in the boundary point subset, and then an intersection boundary line of the two roads closest to each other may be constructed based on boundary points of the two roads closest to each other.

Herein, regarding the closest road for each road, in determining two roads closest to each other are determined, all roads in the intersection may be traversed in the same direction for an intersection. For example, all boundary points in the boundary point subset are traversed in sequence in a clockwise or counterclockwise direction so as to determine a closest road for each road.

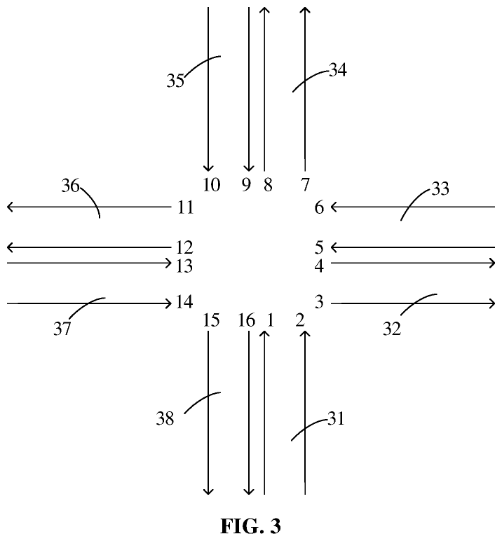

Exemplarily, referring to FIG. 3, FIG. 3 illustrates a schematic diagram of an intersection according to embodiments of the disclosure. As illustrated in FIG. 3, for example, in the at least one road, there is an intersection including eight roads, and the start points of the left and right boundary lines of each road constitute four boundary points. The four boundary points include two start points and two end points. The two start points or the two end points are located in the intersection, and correspondingly, two end points or two start points are located at the other end of the road (not shown). The road and the start points of the road are numbered in combination with the travel direction of the road, etc. so that boundary points 1 and 2 of road 31, boundary points 3 and 4 of road 32, boundary points 5 and 6 of road 33, boundary points 7 and 8 of road 34, boundary points 9 and 10 of road 35, boundary points 11 and 12 of road 36, boundary points 13 and 14 of road 37, boundary points 15 and 16 of road 38 illustrated in FIG. 3 may be obtained. When clustering all the boundary points (start points or end points), by considering factors such as the width of the roads, a corresponding distance may be taken to perform clustering so as to cluster the boundary points in the same intersection into the same set. For example, clustering is performed at a radius of 30 meters. That is, boundary points within a radius of 30 meters are taken as a boundary point subset. The result of the boundary point set actually consists of multiple groups of paired boundary points, each pair of boundary points being start points or end point of a road.

Furthermore, with regard to the obtained boundary point subset, the group of boundary points of a road may be taken arbitrarily, such as boundary point 1 and boundary point 2 in FIG. 3, to calculate the distance from the remaining groups of boundary points to the presently selected boundary point 2. For example, by screening in a counterclockwise direction, the group of points (3, 4) where the boundary point 3 with the smallest distance is located may be connected with the present points (1, 2) to obtain (1, 2, 3, 4) which is the boundary between road 31 and road 32, so that an intersection boundary line can be constructed. The above-mentioned steps are repeated until all boundary points are added to the boundary, that is, the intersection boundary lines of all the roads are found. A boundary is formed by 16 points as illustrated in FIG. 3.

Accordingly, for each group of boundary points, for example points (1, 2) in the figure are the end points of the road 31, and thus the road may be considered as a drive-out road of the intersection. Accordingly, the road 2 with the start points (3, 4) is a drive-in road of the intersection. Thus, drive-in/out road indexes may be added to the intersection element. Meanwhile, an index of the intersection element may be added to a predecessor (that is, a preceding drive-out road) of the drive-out road, and a successor (that is, a succeeding drive-in road) of the drive-in road.

Furthermore, the method further includes the following operations: for each intersection in the at least one road, a direction vector of each lane in the intersection is determined; based on an included angle between direction vectors of every two lanes in the intersection, steering information between the two lanes is determined; and the steering information is added to the road element information.

In this operation, an included angle between the direction vectors of every two lanes may be calculated by the direction vectors of all lanes in the intersection to determine steering information between the two lanes, and the steering information may be added to the road element information.

Herein, the steering information between two lanes may include a left turn, a right turn, straight going and a U-turn.

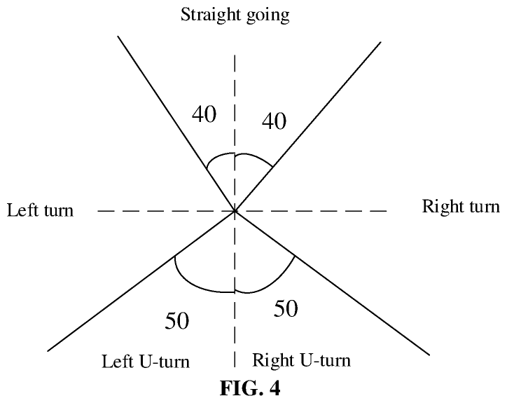

Exemplarily, referring to FIG. 4, FIG. 4 illustrates a schematic diagram of calculation of steering information according to embodiments of the disclosure. As illustrated in FIG. 4, with regard to a drive-in road, the lane of a final road block of the road is traversed, and the direction of an end point of a lane line bound thereto may be taken as the road direction. With regard to a drive-out road, the lane of a first road block of the road is traversed, and the direction of a start point of a lane line bound thereto may be taken as the road direction. Included angles between all the drive-in lanes and the drive-out lanes at the intersection are calculated. The included angles are mapped according to a range as illustrated in FIG. 4, so that steering information of two roads may be obtained. A predecessor-successor relationship of the lane lines may be constructed according to the steering information, and steering is bound.

In some possible embodiments, S202 includes the following operations.

At S2021, for a present road boundary line in the at least two road boundary lines that has not been determined to belong to any road, at least one candidate boundary line parallel to the present road boundary line is determined from the at least two road boundary lines.

In this operation, when determining a boundary line of a road, a road boundary line which has not been determined to belong to any road is taken as a present road boundary line, and a candidate boundary line parallel to the present road boundary line is found out from the at least two road boundary lines.

Specifically, in some possible embodiments, the implementation of S202 may include the following operations: for the present road boundary line in the at least two road boundary lines that has not been determined to belong to any road, a first direction vector of the present road boundary line and a second direction vector of each road boundary line in the at least two road boundary lines other than the present road boundary line are determined. A road boundary line corresponding to a second direction vector parallel to the first direction vector of the present road boundary line among multiple determined second direction vectors is determined as a candidate boundary line of the present road boundary line.

Exemplarily, taking 8 roads in FIG. 3 as an example, each road has two boundary lines, and a total of 16 boundary lines may constitute a boundary line set. For any boundary line Li in the boundary line set, remaining boundary lines Lj in the boundary line set may be traversed, and direction vectors Di and Dj of the boundary lines Li and Lj are respectively calculated, for example, the direction vector at the start point. If Di*Dj is smaller than 0.9, it may be considered that the two direction vectors Di and Dj include an angle therebetween and are not parallel to each other. That is, the boundary line Lj and the boundary line Lj are not parallel to each other, and the next boundary line Lj may be directly traversed. If Di*Dj is greater than 0.9, it may be considered that the boundary line Lj and the boundary line Lj are parallel, and the boundary line Lj may be used as a candidate boundary line of the boundary line Li.

Thus, the two boundary lines of the road are obtained by matching between the direction vectors of the boundary lines, so that the accuracy of boundary line matching can be greatly improved, and the error rate of manual marking can be reduced.

Herein, 0.9 is an exemplary threshold, and different values may be set according to different situations, accuracy requirements, etc.

At S2022, a candidate boundary line with a smallest distance to the present road boundary line is selected from the at least one candidate boundary line as a matching boundary line of the present road boundary line.

In this operation, after at least one candidate boundary line of the present road boundary line is determined, a distance between boundary lines may be determined according to a location relationship between the boundary lines and the like, and then the candidate boundary line having the smallest distance is used as a matching boundary line of the present road boundary line.

Herein, the smallest distance of the candidate boundary line to the present road boundary line may be the distance between the start points of the boundary lines or the distance between the end points of the boundary lines.

Specifically, a first distance between a start point of the present road boundary line and a start point of each of the at least one candidate boundary line and a second distance between an end point of the present road boundary line and an end point of each of the at least one candidate boundary line may be determined first. Then a candidate boundary line having a smallest first distance and a smallest second distance is determined as the candidate boundary line with the smallest distance to the present road boundary line. Next, the determined candidate boundary line with the smallest distance is taken as the matching boundary line of the present road boundary line.

Exemplarily, after multiple candidate boundary lines of the boundary line Li are obtained, that is, multiple boundary lines Lj are obtained by matching through a direction vector, a distance d1 between start points of Li and Lj and a distance d2 between end points of Li and Lj may be calculated for each boundary line Lj. If d1 and/or d2 is greater than a certain road width threshold, for example 30 meters, it may be considered that the boundary line Li and the boundary line Lj belong to different roads, and the next boundary line Lj may continue to be traversed. If d1 and d2 are both less than the road width threshold, it may be considered that the boundary line Li and the boundary line Lj belong to the same road. Accordingly, the distance between the start points or end points of two boundary lines belonging to the same road is the shortest.

At S2023, at least one lane line located between the present road boundary line and the matching boundary line is determined from the multiple lane lines to obtain a belonging road including the present road boundary line, the matching boundary line, and the determined at least one lane line.

In this operation, after the present road boundary line and the matching boundary line constituting a road are determined, at least one lane line located between the present road boundary line and the matching boundary line may be determined through factors such as location information, thereby obtaining a corresponding road.

Thus, two boundary lines belonging to the same road can be selected effectively through pairing between the two boundary lines with the shortest distance. The boundary lines and lane lines constituting the road may be obtained quickly and effectively with high accuracy by matching the lane lines in such a manner.

Further, after two boundary lines of a road are determined, that is, the present road boundary line and the matching boundary line, the boundary attributes of the present road boundary line and the matching boundary line may be further confirmed, that is, confirming whether the present road boundary line is a left boundary line or a right boundary line. Accordingly, the method includes the following operations:

A vector between a first road point on the present road boundary line and a second road point on the matching boundary line corresponding to the first road point is determined. Boundary attributes of the present road boundary line and the matching boundary line with respect to a road centerline of the belonging road are determined according to the vector between the first road point and the second road point and the first direction vector or according to the vector between the first road point and the second road point and the second direction vector of the matching boundary line. The boundary line attributes includes a left side boundary line and a right side boundary line. The determined boundary attributes of the present road boundary line and the matching boundary line are added to the road element information.

Thus, the boundary attributes of the boundary lines are determined by vector matching between the boundary lines and the road centerline, so that the accuracy of the boundary attributes can be improved, and the marking error can be reduced.

Herein, the first road point may be a start point of the present road boundary line, an end point of the present road boundary line or any point in the present boundary line. Accordingly, the second road point may also be a start point of the matching boundary line, an end point of the matching boundary line or any point in the matching boundary line.

Herein, in determining the boundary attributes of the present road boundary line and the matching boundary line with respect to the road centerline of the belonging road, it is feasible to calculate the boundary attribute of only one of the present road boundary line and the matching boundary line. For example, if it is determined from the vector between the first road point and the second road point and the first direction vector that the present road boundary line is a left boundary line, the matching boundary line is correspondingly a right boundary line.

Exemplarily, taking the first road point and the second road point as start points of boundary lines respectively as an example, a vector v1 may be formed by taking start point Pi of a boundary line Li as a start point and taking start point Pj of a boundary line Lj as an end point. The vector v1 is multiplied (cross-multiplied) by a direction vector Di of the boundary line Li. If the result of multiplication is greater than 0, the boundary Lj may be considered as a right boundary line, and the boundary line Li may be considered as a left boundary line. Otherwise, the boundary line Lj is a left boundary line, and the boundary line Li is a right boundary line. Accordingly, road elements corresponding to the boundary line attributes of the boundary line Li and the boundary line Lj may be established, and the matched left and right boundary lines are added, that is, the boundary line attributes corresponding to the boundary line Li and the boundary line Lj are added to the road element information.

Furthermore, in S2022, the at least one lane line located between the present road boundary line and the matching boundary line may be determined by following operations: a polygon defined by the present road boundary line and the matching boundary line is determined; and the multiple lane lines area traversed, and a lane line located within the polygon is determined as a lane line located between the present road boundary line and the matching boundary line.

In this operation, a polygon may be enclosed by combining the start point and the end point of the present road boundary line and the start point and the end point of the matching boundary line. Accordingly, the lane line located in the polygon may be determined as a lane line located between the present road boundary line and the matching boundary line, that is, the lane line of the road including the present road boundary line and the matching boundary line, by combining the location information the boundary line and the location information of the lane line.

Exemplarily, for completing construction of boundaries of the road, the lane line may be bound to the road by matching the boundary line with the lane line. For example, for any lane line Lk and a boundary Li of any road, a start point P0 and an end point P1 of the lane line may be extracted, and whether the start point P0 and the end point P1 are within the polygon formed by the boundary lines of the road may be calculated by factors such as location information. If yes, the matching is successful. The lane line may be bound to the road, and an index of the lane line may be added to a corresponding road element.

In some possible embodiments, S203 includes the following operations.

At S2031, for a present road in the at least one road that has not been divided into road blocks, at least one road line of the present road is determined based on the at least one lane line of the present road, each road line including a lane line or multiple consecutively connected lane lines.

In this operation, in order to facilitate adding navigation elements to the road, a road unit is refined, and the road may be divided into road blocks of smaller units. Therefore, for a present road which has not been divided into road blocks, at least one road line for dividing the present road may be determined through at least one lane line in the present road.

Herein, the road line includes a lane line or multiple consecutively connected lane lines. The multiple consecutively connected lane lines mainly refer to multiple lane lines located on the same straight line. In view of different locations, functions and attributes, most lane lines commonly used at present include dotted lines and solid lines. For example, in a long-distance road, most lane lines are dotted lines, and lane lines near the end of the road or at some locations of the road are solid lines. Therefore, such lane lines that are actually located on the same straight line and connected consecutively may be combined into a road line.

Specifically, at least one road line in the present road may be determined in the following way: firstly, for the present road in the at least one road which is not divided into road blocks, at least one target lane line having a start point flush with a start point of a boundary line of the present road is determined from the at least one lane line in the present road; and then each of the at least one target lane line is taken as a start lane line in a belonging road line to determine another lane line directly connected or indirectly connected to the start lane line. The belonging road line is constituted by the start lane line and the another lane line directly connected or indirectly connected to the start lane line.

Herein, besides the lane lines classified into road lines, there are some lane lines which are directly located in the road, have no start point flush with the boundary line of the road, and are directly connected or indirectly connected to no starting lane line preceding. For example, in the case where there is a branching road or a side road emerging from a certain location in the road, there may be lane lines starting from the start point of the branching road or the start point of the side road and being not flush with the boundary line of the road. In such a case, such lane lines may also be considered as starting lane lines in calculation, or may form road lines via corresponding road boundary lines so as to perform division of road blocks.

Furthermore, the at least one target lane line having the start point flush with the start point of the boundary line of the present road may be determined from the at least one lane line in the present road in the following way: for the present road in at least one road that has not been divided into road blocks, an acute angle included between a first straight line where a connection line between a start point of a lane line of the present road and the start point of the boundary line of the present road is located and a second straight line which is perpendicular to the boundary line are determined; and then in response to that the acute angle is smaller than a preset threshold, the corresponding lane line is determined as a target lane line flush with the start point of the boundary line of the present road.

Herein, the lane line is one of the at least one lane line of the present road, and the first straight line and the second straight line are coplanar.

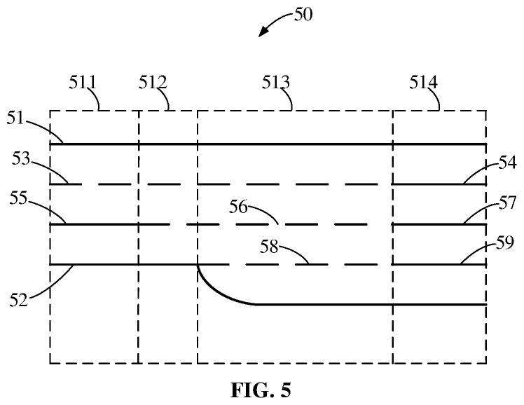

Exemplarily, referring to FIG. 5, FIG. 5 illustrates a schematic diagram of division of road blocks according to embodiments of the disclosure. As illustrated in FIG. 5, taking a road 50 which has not been divided into road blocks as an example, the lane lines within the road elements at this moment are of different lengths and need to be neatly divided. The road 50 includes two boundary lines and multiple lane lines. Specifically, the road 50 includes a boundary line 51 and a boundary line 52, and further includes a lane line 53, a lane line 54, a lane line 55, a lane line 56, a lane line 57, a lane line 58 and a lane line 59. Herein, the lane line 53 and the lane line 54 are located on the same straight line, the lane line 55, the lane line 56 and the lane line 57 are located on the same straight line, and the lane line 58 and the lane line 59 are located on the same straight line. In performing division of road blocks, for multiple lane lines in the road, a unit vector dir1 of a vector formed by the start point P0 of any lane line (for example, the lane line 53) and the start point BO of any boundary line (for example, the boundary line 51) of the road may be calculated, and the product of the dir1 and the direction vector dir2 of the road boundary line is calculated. If the product is less than 0.2, it may be considered that the lane line is flush with the boundary line, and the lane line may be used as a starting lane line in a road line. The road line is created with the lane line. However, the lane line 58 is a lane line that appears after adding a lane to the road 50, and the start point of the lane line 58 begins at a place where the curve appears on the boundary line 52. Therefore, the lane line 58 may also be considered to be flush with the boundary line where the curve appears, that is, the lane line 58 may also be used as a starting lane line constituting a road line. Then, the remaining lane lines may be traversed. The distances between the start points of the remaining lane lines and the end point of the already obtained part of road line are calculated. If the distance is less than a certain threshold, for example 0.2 meters, the lane line may be correspondingly assigned to the road line. For example, after the lane line 53 is obtained as the starting lane line, the road line is constructed with the lane line 53. At this moment, the end point of the road line is the end point of the lane line 53, and other lane lines are traversed to obtain. It is obtained that the distances between the start point of the lane line 54 and the end point of the lane line 53 is 0. The lane line 54 may be classified into the road line to which the lane line 53 belongs to obtain a road line 510 constituted by the lane line 53 and the lane line 54. The division method of the lane line 55 to the lane line 57 is the same, whereby other lane lines directly or indirectly connected to the starting lane line may be obtained to jointly constitute a corresponding road line. The remaining lane lines are traversed continuously until all the lane lines join a road line. So far, it is completed that all the lane lines form road lines in a sequentially connected order. The above process is repeated until correlated calculation has been completed for all the lane lines, and all road lines are obtained.

At S2032, two boundary lines and the at least one road line of the present road are cut according to a start point of each lane line in each of the at least one road line of the present road to obtain multiple consecutively arranged road blocks of the present road.

In this operation, after road lines are obtained, the lanes are divided according to the start point of each lane line in each road line, so as to obtain multiple road blocks.

Specifically, a distance between a start point of each lane line in each road line and a start point of a boundary line of the present road may be determined firstly. Then, each boundary line and each road line of the present road are cut along a lane direction of the present road in an order of distance from small to large using the start point of each lane line as a cutting point in sequence. Next, it is determined that every two sub-boundary lines corresponding to each other obtained after the cutting and at least one lane line segment located between the two sub-boundary lines enclose a road block, to finally obtain multiple consecutively arranged road blocks of the present road

Exemplarily, after the road lines in the road are obtained, the lane lines in all the road lines in the road may be traversed from front to back at the same time. For example, the lane lines 53 and 54 in the road line 510 may be found. The distance between the end point of each lane line and the start point of any boundary line is calculated, and then the other lane lines and boundary lines are cut using the corresponding start points in an order of distance from small to large. For example, the lane lines and boundary lines of the road are cut using the start points of the lane line 56, the lane line 57 and the lane line 58 in sequence, and the cut lines are divided into two. The cut lines include lane lines and boundary lines. After the traversal is completed, lane sub-lines and boundary sub-lines cut neatly are formed, and then a road block including two corresponding parallel boundary sub-lines and a lane sub-line therein may be obtained, for example, a road block 511, a road block 512, a road block 513 and a road block 514 in FIG. 5.

According to the method for constructing a navigation element in a map provided in the embodiment of the disclosure, various kinds of road information are recognized through semantic map data, roads are divided through lane lines, and road elements are added to the divided road blocks according to location information of the road elements so as to obtain a navigation map, thereby achieving completely automatic construction of the elements. An error rate of road element marking can be reduced, and a large amount of marking time and labor costs are saved. Both time and labor are saved, and a high accuracy is achieved.

It can be understood by those skilled in the art that, in the above-mentioned method of the detailed description, the writing sequence of operations does not mean to form any limitation to the implementation process with a strict execution sequence and a specific execution sequence of various operations should be determined by functions and possible internal logic thereof.

Based on the same inventive concept, the embodiments of the disclosure also provide an apparatus for constructing a navigation element in a map corresponding to the method for constructing a navigation element in a map. Since the principle of solving problems by the apparatus in the embodiments of the disclosure is similar to the method for constructing a navigation element in a map described above in the embodiments of the disclosure, the implementation of the apparatus may refer to the implementation of the method, and the repetitions are not repeated here.

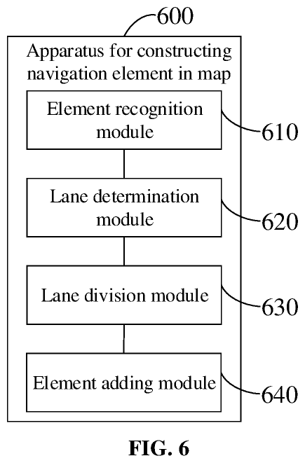

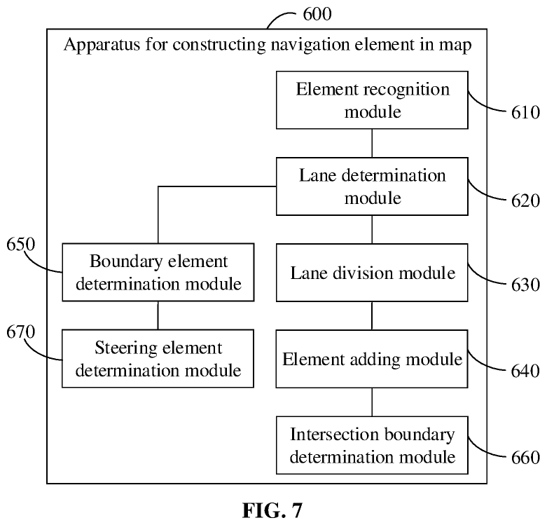

Referring to FIGS. 6 and 7, FIG. 6 illustrates a schematic diagram I of an apparatus for constructing a navigation element in a map according to embodiments of the disclosure. FIG. 7 illustrates a schematic diagram II of an apparatus for constructing a navigation element in a map according to embodiments of the disclosure. As illustrated in FIG. 6, the apparatus for constructing a navigation element in a map provided in the embodiments of the disclosure includes: an element recognition module 610, a lane determination module 620, a lane division module 630, and an element adding module 640.

The element recognition module 610 is configured to recognize, according to semantic map data of a target area, road element information in the target area and at least two road boundary lines and multiple lane lines in the road element information.

The lane determination module 620 is configured to determine at least one road in the target area and at least one lane line located in each of the at least one road based on the at least two road boundary lines and the multiple lane lines that are recognized.

The lane division module 630 is configured to divide each of the at least one road into multiple consecutively arranged road blocks based on the at least one lane line in the road.

The element adding module 640 is configured to add each road element to a corresponding road block according to location information of the road element in the road element information to obtain a navigation map for road navigation.

In an optional implementation, the lane determination module 620 is specifically configured to: determine, for a present road boundary line in the at least two road boundary lines that has not been determined to belong to any road, at least one candidate boundary line parallel to the present road boundary line from the at least two road boundary lines; select, from the at least one candidate boundary line, a candidate boundary line with a smallest distance to the present road boundary line as a matching boundary line of the present road boundary line; and determine, from the multiple lane lines, at least one lane line located between the present road boundary line and the matching boundary line to obtain a belonging road containing the present road boundary line, the matching boundary line, and the at least one lane line determined.

In an optional implementation, in determining, for the present road in the at least two road boundary lines that has not been determined to belong to any road, the at least one candidate boundary line parallel to the present road boundary line from the at least two road boundary lines, the lane determination module 620 is specifically configured to: determine, for the present road boundary line in the at least two road boundary lines that has not been determined to belong to any road, a first direction vector of the present road boundary line and a second direction vector of each road boundary line in the at least two road boundary lines other than the present road boundary line; and determine a road boundary line corresponding to a second direction vector parallel to the first direction vector of the present road boundary line among multiple determined second direction vectors as a candidate boundary line of the present road boundary line.

In an optional implementation, as illustrated in FIG. 7, the apparatus 600 for constructing a navigation element in a map further includes a boundary element determination module 650. The boundary element determination module 650 is configured to: determine a vector between a first road point on the present road boundary line and a second road point on the matching boundary line corresponding to the first road point; determine boundary attributes of the present road boundary line and the matching boundary line with respect to a road centerline of the belonging road according to the vector between the first road point and the second road point and the first direction vector or according to the vector between the first road point and the second road point and the second direction vector of the matching boundary line, the boundary line attributes including a left-side boundary line and a right-side boundary line; and add the determined boundary attributes of the present road boundary line and the matching boundary line to the road element information.

In an optional implementation, in selecting, from the at least one candidate boundary line, the candidate boundary line with the smallest distance to the present road boundary line as the matching boundary line of the present road boundary line, the lane determination module 620 is specifically configured to: determine a first distance between a start point of the present road boundary line and a start point of each of the at least one candidate boundary line and a second distance between an end point of the present road boundary line and an end point of each of the at least one candidate boundary line; determine a candidate boundary line having a smallest first distance and a smallest second distance as the candidate boundary line with the smallest distance to the present road boundary line; and take the determined candidate boundary line with the smallest distance as the matching boundary line of the present road boundary line.

In an optional implementation, the lane determination module 620 is configured to determine the at least one lane line located between the present road boundary line and the matching boundary line by following operations: determining a polygon defined by the present road boundary line and the matching boundary line; and traverse the multiple lane lines, and determining a lane line located within the polygon as a lane line located between the present road boundary line and the matching boundary line.

In an optional implementation, the lane division module 630 is specifically configured to: determine, for a present road in the at least one road that has not been divided into road blocks, at least one road line of the present road based on the at least one lane line of the present road, each road line including a lane line or multiple consecutively connected lane lines; and cut two boundary lines and the at least one road line of the present road according to a start point of each lane line in each of the at least one road line of the present road to obtain multiple consecutively arranged road blocks of the present road.

In an optional implementation, in determining, for the present road in the at least one road that has not been divided into road blocks, the at least one road line of the present road based on the at least one lane line of the present road, the lane division module 630 is specifically configured to: determine, for the present road in the at least one road that has not been divided into road blocks, at least one target lane line having a start point flush with a start point of a boundary line of the present road from the at least one lane line in the present road; and take each of the at least one target lane line as a start lane line in a belonging road line to determine another lane line directly connected or indirectly connected to the start lane line. The belonging road line is constituted by the start lane line and the another lane line directly connected or indirectly connected to the start lane line.

In an optional implementation, in determining, for the present road in at least one road that has not been divided into blocks, the at least one target lane line having the start point flush with the start point of the boundary line of the present road from the at least one lane line in the present road, the lane division module 630 is specifically configured to: determine, for the present road in at least one road that has not been divided into road blocks, an acute angle included between a first straight line where a connection line between a start point of a lane line of the present road and the start point of the boundary line of the present road is located and a second straight line which is perpendicular to the boundary line, the lane line being one of the at least one lane line of the present road, and the first straight line and the second straight line are coplanar; and in response to that the acute angle is smaller than a preset threshold, determine the corresponding lane line as a target lane line flush with the start point of the boundary line of the present road.

In an optional implementation, in cutting the two boundary lines and the at least one road line of the present road according to the start point of each lane line in each of the at least one road line of the present road to obtain the multiple consecutively arranged road blocks of the present road, the lane division module 630 is specifically configured to: determine a distance between a start point of each lane line in each road line and a start point of a boundary line of the present road; cut each boundary line and each road line of the present road along a lane direction of the present road in an order of distance from small to large using the start point of each lane line as a cutting point in sequence; and determine that every two sub-boundary lines corresponding to each other obtained after the cutting and at least one lane line segment located between the two sub-boundary lines enclose a road block, to obtain multiple consecutively arranged road blocks of the present road.

In an optional implementation, as illustrated in FIG. 7, the apparatus 600 for constructing a navigation element in a map further includes an intersection boundary determination module 660. The intersection boundary determination module 660 is configured to: in response to that the at least one road contains an intersection including at least one road start end and at least one road terminating end close to each other, determine a boundary point set including multiple boundary points based on a start point and an end point of a road boundary line that are located at the intersection, each of the at least one road start end being a start end of a road in the at least one road, and each of the at least one road terminating end is a terminating end of a road in the at least one road; cluster, according to a preset radius threshold, the multiple boundary points in the boundary point set to obtain at least one boundary point subset; and determine an intersection boundary line of every two roads according to distances each between corresponding boundary points of two roads in a boundary point subset.

In an optional implementation, in determining the intersection boundary line of every two roads according to the distances each between the corresponding boundary points of two roads in a boundary point subset, the intersection boundary determination module 660 is specifically configured to: determine, for each boundary point subset, a closest road for each road according to locations of all boundary points in the boundary point subset; and constructing an intersection boundary line of two roads closest to each other based on boundary points of the two roads closest to each other.

In an optional implementation, as illustrated in FIG. 7, the apparatus 600 for constructing a navigation element in a map further includes a steering element determination module 670. The steering element determination module 670 is configured to: determine, for each intersection in the at least one road, a direction vector of each lane in the intersection; determine, based on an included angle between direction vectors of every two lanes in the intersection, steering information between the two lanes; and add the steering information to the road element information.

According to the apparatus for constructing a navigation element in a map provided by the embodiment of the disclosure, various kinds of road information are recognized through semantic map data, roads are divided through lane lines, and road elements are added to the divided road blocks according to location information of the road elements so as to obtain a navigation map, thereby achieving completely automatic construction of the elements. An error rate of road element marking can be reduced, and a large amount of marking time and labor costs are saved. Both time and labor are saved, and a high accuracy is achieved.

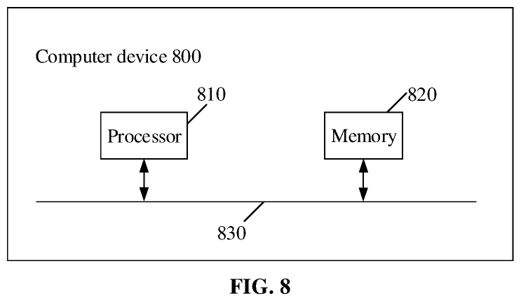

The embodiments of the disclosure also provide a computer device 800, As illustrated in FIG. 8, which is a structural schematic diagram of a computer device 800 according to embodiments of the disclosure, including: a processor 810, a memory 820, and a bus 830. The memory 820 stores machine-readable instructions executable by the processor 810. When the computer device 800 runs, the processor 810 and the memory 820 are communicated through the bus 830. When executed by the processor 810, the machine-readable instructions execute the operations of the method for constructing a navigation element in a map as illustrated in FIGS. 1 and 2.

The specific execution process of the above instructions may refer to the operations of the method for constructing a navigation map in a map, which is not repeated here.

The embodiments of the disclosure further provide a computer-readable storage medium, and a computer program is stored on the computer-readable storage medium. When run by a processor, the computer program executes the operations of the method for constructing a navigation element in a map in the above method embodiments. Herein, the storage medium may be a volatile or nonvolatile computer readable storage medium.

Herein, the computer program product may be specifically implemented by means of hardware, software or a combination thereof. In an optional embodiment, the computer program product is specifically embodied as a computer storage medium, and in another optional embodiment, the computer program product is specifically embodied as software products, such as a Software Development Kit (SDK).

The embodiments of the disclosure further provide a computer program product, including a computer readable code, or a nonvolatile computer readable storage medium carrying a computer readable code. When the computer readable code runs in a processor of an electronic device, the processor of the electronic device executes the operations of the above-mentioned method for constructing a navigation element in a map.

Those skilled in the art may clearly learn about that specific working processes of the system and apparatus described above may refer to the corresponding processes in the above-mentioned method embodiments and will not be elaborated herein for ease and briefness of description. In the several embodiments provided in the disclosure, it should be understood that the disclosed system, apparatus and method may be implemented in other manners. The apparatus embodiments described above are only illustrative, and for example, division of the units is only division in logic functions, and other division manners may be adopted during practical implementation. For another example, multiple units or components may be combined or integrated into another system, or some characteristics may be neglected or not executed. In addition, coupling or direct coupling or communication connection between each displayed or discussed component may be indirect coupling or communication connection implemented through some communication interfaces, device or units, and may be electrical, mechanical or in other forms.

The units described as separate parts may or may not be physically separated, and parts displayed as units may or may not be physical units, namely they may be located in the same place, or may be distributed to multiple network units. Part or all of the units may be selected to achieve the purposes of the solutions of the embodiments according to a practical requirement.

In addition, functional units in the embodiments of the disclosure may be integrated into one processing unit, or each of the units may exist alone physically, or two or more units are integrated into one unit.

When realized in form of software function unit and sold or used as an independent product, the function may be stored in a nonvolatile computer-readable storage medium executable by a processor. Based on such an understanding, the technical solutions of the disclosure substantially or parts making contributions to the conventional art or part of the technical solutions may be embodied in form of software product. The computer software product is stored in a storage medium, including several instructions configured to enable a computer device (which may be a personal computer, a server, a network device, etc.) to execute all or part of the operations of the method in various embodiments of the disclosure. The above-mentioned storage medium includes: various media capable of storing program codes such as a USB flash disk, a mobile hard disk, a Read-Only Memory (ROM), a Random Access Memory (RAM), a magnetic disk, or an optical disk.

It is finally to be noted that the above embodiments are only detailed description of the disclosure and are not intended to limit the disclosure but to describe the technical solutions of the disclosure, and the scope of protection of the disclosure is not limited thereto. Although the disclosure is described with reference to the embodiments in detail, those of ordinary skill in the art should know that those skilled in the art may still make modifications or apparent variations to the technical solutions disclosed in the embodiments or make equivalent replacements to part of technical features within the technical scope disclosed in the disclosure, and these modifications, variations, or replacements, without making the essence of the corresponding technical solutions departs from the spirit and scope of the technical solutions of the embodiments of the disclosure, shall fall within the scope of protection of the disclosure. Therefore, the scope of protection of the disclosure shall be subject to the scope of protection of the claims.

1. A method for constructing a navigation element in a map, comprising:
recognizing, according to semantic map data of a target area, road element information in the target area and at least two road boundary lines and a plurality of lane lines in the road element information;
determining at least one road in the target area and at least one lane line located in each of the at least one road based on the at least two road boundary lines and the plurality of lane lines that are recognized;
dividing each of the at least one road into a plurality of consecutively arranged road blocks based on the at least one lane line in the road; and
adding each road element to a corresponding road block according to location information of the road element in the road element information to obtain a navigation map for road navigation.

2. The method of claim 1, wherein determining the at least one road in the target area and the at least one lane line located in each of the at least one road based on the at least two road boundary lines and the plurality of lane lines that are recognized comprises:
determining, for a present road boundary line in the at least two road boundary lines that has not been determined to belong to any road, at least one candidate boundary line parallel to the present road boundary line from the at least two road boundary lines;
selecting, from the at least one candidate boundary line, a candidate boundary line with a smallest distance to the present road boundary line as a matching boundary line of the present road boundary line; and
determining, from the plurality of lane lines, at least one lane line located between the present road boundary line and the matching boundary line to obtain a belonging road containing the present road boundary line, the matching boundary line, and the at least one lane line determined.

3. The method of claim 2, wherein determining, for the present road boundary line in the at least two road boundary lines that has not been determined to belong to any road, the at least one candidate boundary line parallel to the present road boundary line from the at least two road boundary lines comprises:
determining, for the present road boundary line in the at least two road boundary lines that has not been determined to belong to any road, a first direction vector of the present road boundary line and a second direction vector of each road boundary line in the at least two road boundary lines other than the present road boundary line; and
determining a road boundary line corresponding to a second direction vector parallel to the first direction vector of the present road boundary line among a plurality of determined second direction vectors as a candidate boundary line of the present road boundary line.

4. The method of claim 3, further comprising:
determining a vector between a first road point on the present road boundary line and a second road point on the matching boundary line corresponding to the first road point;
determining boundary attributes of the present road boundary line and the matching boundary line with respect to a road centerline of the belonging road according to the vector between the first road point and the second road point and the first direction vector or according to the vector between the first road point and the second road point and the second direction vector of the matching boundary line, wherein the boundary attributes comprise a left-side boundary line and a right-side boundary line; and
adding the determined boundary attributes of the present road boundary line and the matching boundary line to the road element information.

5. The method of claim 2, wherein selecting, from the at least one candidate boundary line, the candidate boundary line with the smallest distance to the present road boundary line as the matching boundary line of the present road boundary line comprises:
determining a first distance between a start point of the present road boundary line and a start point of each of the at least one candidate boundary line and a second distance between an end point of the present road boundary line and an end point of each of the at least one candidate boundary line;
determining a candidate boundary line having a smallest first distance and a smallest second distance as the candidate boundary line with the smallest distance to the present road boundary line; and
taking the determined candidate boundary line with the smallest distance as the matching boundary line of the present road boundary line.

6. The method of claim 2, wherein the at least one lane line located between the present road boundary line and the matching boundary line is determined by following operations:
determining a polygon defined by the present road boundary line and the matching boundary line; and
traversing the plurality of lane lines, and determining a lane line located within the polygon as a lane line located between the present road boundary line and the matching boundary line.

7. The method of claim 1, wherein dividing each of the at least one road into the plurality of consecutively arranged road blocks based on the at least one lane line in the road comprises:
determining, for a present road in the at least one road that has not been divided into road blocks, at least one road line of the present road based on the at least one lane line of the present road, each road line comprising a lane line or a plurality of consecutively connected lane lines; and
cutting two boundary lines and the at least one road line of the present road according to a start point of each lane line in each of the at least one road line of the present road to obtain a plurality of consecutively arranged road blocks of the present road.

8. The method of claim 7, wherein determining, for the present road in the at least one road that has not been divided into road blocks, the at least one road line of the present road based on the at least one lane line of the present road comprises:
determining, for the present road in the at least one road that has not been divided into road blocks, at least one target lane line having a start point flush with a start point of a boundary line of the present road from the at least one lane line in the present road; and
taking each of the at least one target lane line as a start lane line in a belonging road line, and determining another lane line directly connected or indirectly connected to the start lane line, wherein the belonging road line is constituted by the start lane line and the another lane line directly connected or indirectly connected to the start lane line.

9. The method of claim 8, wherein determining, for the present road in at least one road that has not been divided into blocks, the at least one target lane line having the start point flush with the start point of the boundary line of the present road from the at least one lane line in the present road comprises:
determining, for the present road in at least one road that has not been divided into road blocks, an acute angle included between a first straight line where a connection line between a start point of a lane line of the present road and the start point of the boundary line of the present road is located and a second straight line which is perpendicular to the boundary line, wherein the lane line is one of the at least one lane line of the present road, and the first straight line and the second straight line are coplanar; and
in response to that the acute angle is smaller than a preset threshold, determining the corresponding lane line as a target lane line flush with the start point of the boundary line of the present road.

10. The method of claim 7, wherein cutting the two boundary lines and the at least one road line of the present road according to the start point of each lane line in each of the at least one road line of the present road to obtain the plurality of consecutively arranged road blocks of the present road comprises:
determining a distance between a start point of each lane line in each road line and a start point of a boundary line of the present road;
cutting each boundary line and each road line of the present road along a lane direction of the present road in an order of distance from small to large using the start point of each lane line as a cutting point in sequence; and
determining that every two sub-boundary lines corresponding to each other obtained after the cutting and at least one lane line segment located between the two sub-boundary lines enclose a road block, to obtain a plurality of consecutively arranged road blocks of the present road.

11. The method of claim 1, further comprising:
in response to that the at least one road contains an intersection including at least one road start end and at least one road terminating end close to each other, determining a boundary point set including a plurality of boundary points based on a start point and an end point of a road boundary line that are located at the intersection, wherein each of the at least one road start end is a start end of a road in the at least one road, and each of the at least one road terminating end is a terminating end of a road in the at least one road;
clustering, according to a preset radius threshold, the plurality of boundary points in the boundary point set to obtain at least one boundary point subset; and
determining an intersection boundary line of every two roads according to distances each between corresponding boundary points of two roads in a boundary point subset.

12. The method of claim 11, wherein determining the intersection boundary line of every two roads according to the distances each between the corresponding boundary points of two roads in a boundary point subset comprises:
determining, for each boundary point subset, a closest road for each road according to locations of all boundary points in the boundary point subset; and
constructing an intersection boundary line of two roads closest to each other based on boundary points of the two roads closest to each other.

13. The method of claim 12, further comprising:
determining, for each intersection in the at least one road, a direction vector of each lane in the intersection;
determining, based on an included angle between direction vectors of every two lanes in the intersection, steering information between the two lanes; and
adding the steering information to the road element information.

14. A computer device, comprising a processor, a memory and a bus, wherein the memory stores machine-readable instructions executable by the processor that communicates, when the computer device runs, with the memory through the bus to execute the machine-readable instructions to executing a method for constructing a navigation element in a map, the method comprising:
recognizing, according to semantic map data of a target area, road element information in the target area and at least two road boundary lines and a plurality of lane lines in the road element information;
determining at least one road in the target area and at least one lane line located in each of the at least one road based on the at least two road boundary lines and the plurality of lane lines that are recognized;
dividing each of the at least one road into a plurality of consecutively arranged road blocks based on the at least one lane line in the road; and
adding each road element to a corresponding road block according to location information of the road element in the road element information to obtain a navigation map for road navigation.

15. The computer device of claim 14, wherein determining the at least one road in the target area and the at least one lane line located in each of the at least one road based on the at least two road boundary lines and the plurality of lane lines that are recognized comprises:
determining, for a present road boundary line in the at least two road boundary lines that has not been determined to belong to any road, at least one candidate boundary line parallel to the present road boundary line from the at least two road boundary lines;
selecting, from the at least one candidate boundary line, a candidate boundary line with a smallest distance to the present road boundary line as a matching boundary line of the present road boundary line; and
determining, from the plurality of lane lines, at least one lane line located between the present road boundary line and the matching boundary line to obtain a belonging road containing the present road boundary line, the matching boundary line, and the at least one lane line determined.

16. The computer device of claim 15, wherein determining, for the present road boundary line in the at least two road boundary lines that has not been determined to belong to any road, the at least one candidate boundary line parallel to the present road boundary line from the at least two road boundary lines comprises:
determining, for the present road boundary line in the at least two road boundary lines that has not been determined to belong to any road, a first direction vector of the present road boundary line and a second direction vector of each road boundary line in the at least two road boundary lines other than the present road boundary line; and
determining a road boundary line corresponding to a second direction vector parallel to the first direction vector of the present road boundary line among a plurality of determined second direction vectors as a candidate boundary line of the present road boundary line.

17. The computer device of claim 16, wherein the method further comprises:
determining a vector between a first road point on the present road boundary line and a second road point on the matching boundary line corresponding to the first road point;
determining boundary attributes of the present road boundary line and the matching boundary line with respect to a road centerline of the belonging road according to the vector between the first road point and the second road point and the first direction vector or according to the vector between the first road point and the second road point and the second direction vector of the matching boundary line, wherein the boundary attributes comprise a left-side boundary line and a right-side boundary line; and
adding the determined boundary attributes of the present road boundary line and the matching boundary line to the road element information.

18. The computer device of claim 15, wherein selecting, from the at least one candidate boundary line, the candidate boundary line with the smallest distance to the present road boundary line as the matching boundary line of the present road boundary line comprises:
determining a first distance between a start point of the present road boundary line and a start point of each of the at least one candidate boundary line and a second distance between an end point of the present road boundary line and an end point of each of the at least one candidate boundary line;
determining a candidate boundary line having a smallest first distance and a smallest second distance as the candidate boundary line with the smallest distance to the present road boundary line; and
taking the determined candidate boundary line with the smallest distance as the matching boundary line of the present road boundary line.

19. The computer device of claim 15, wherein the at least one lane line located between the present road boundary line and the matching boundary line is determined by following operations:
determining a polygon defined by the present road boundary line and the matching boundary line; and
traversing the plurality of lane lines, and determining a lane line located within the polygon as a lane line located between the present road boundary line and the matching boundary line.

20. A non-transitory computer-readable storage medium having stored thereon a computer program that, when run by a processor, enables the processor to execute following operations:
recognizing, according to semantic map data of a target area, road element information in the target area and at least two road boundary lines and a plurality of lane lines in the road element information;
determining at least one road in the target area and at least one lane line located in each of the at least one road based on the at least two road boundary lines and the plurality of lane lines that are recognized;
dividing each of the at least one road into a plurality of consecutively arranged road blocks based on the at least one lane line in the road; and
adding each road element to a corresponding road block according to location information of the road element in the road element information to obtain a navigation map for road navigation.
